(19) United States
(12) Patent Application Publication
(10) Pub. No.: US 2007/0278325 A1
(43) Pub. Date: Dec. 6, 2007

(54) HEADLAMP CLEANER

(75) Inventors: Masaaki SATO, Shizuoka-shi (JP); Masaru SAKAI, Shizuoka-shi (JP)

Correspondence Address: SUGHRUE-265550, 2100 PENNSYLVANIA AVE. NW, WASHINGTON, DC, 20037-3213, US

(73) Assignee: KOITO MANUFACTURING CO., LTD., Tokyo (JP)

(21) Appl. No.: 11/757,432

(22) Filed: Jun. 4, 2007

(30) Foreign Application Priority Data
Jun. 2, 2006 (JP) 2006-154309
Mar. 28, 2007 (JP) 2007-083537

(51) Int. Cl. B05B 1/10; A62C 11/00

(52) U.S. Cl. 239/284.2; 239/329

(57) ABSTRACT

A headlamp cleaner includes a tank in which a cleaning fluid is stored, a motor pump which pumps the cleaning fluid stored inside the tank, a fluid path through which the cleaning fluid pumped by the motor pump is pressure-transferred, and a nozzle from which the cleaning fluid pressure-transferred through the fluid path is ejected toward a headlamp. The fluid path mainly includes a hose made of a rigid material such as plastic.

The present invention claims priority from Japanese Patent Applications No. 2006-154309 filed on Jun. 2, 2006, and No. 2007-083537 filed on Mar. 28, 2007, the entire contents of which are incorporated herein by reference.

### BACKGROUND OF INVENTION

1. Field of the Invention

The invention relates to a headlamp cleaner which ejects a cleaning fluid toward a headlamp of a vehicle to clean the headlamp. More specifically, the present invention relates to an improvement of a fluid path of the headlamp cleaner.

2. Description of the Related Art

Some vehicles, such as cars, are mounted with a headlamp cleaner in order to clean a surface of a headlamp with a cleaning fluid so that the surface of the headlamp is prevented from being unclear due to dirt resulting from, e.g., melted snow. Headlamp cleaners are mounted, in particular, on vehicles used in Europe since it is obligatory to mount a headlamp cleaner for a vehicle employing a discharge lamp in Europe.

When functionality (e.g., a light distribution) of the headlamp is deteriorated due to an adhesion of dirt, the headlamp cleaner cleans the surface of the headlamp, whereby the function of the headlamp is restored so that visibility is ensured.

As shown in FIGS. 7 and 8, such a headlamp cleaner includes a tank 50 in which a cleaning fluid is stored, a motor pump 52 which pumps the cleaning fluid inside the tank 50, nozzles 54, 56 which eject the cleaning fluid pumped by the motor pump 52 toward respective headlamps (not shown), and a fluid path 58 which couples the motor pump 52 and the respective nozzles 54, 56. The fluid path 58 is mainly formed by a hose 60 such as a rubber hose (seer e.g., JP-A-2003-2857235). The rubber hose is made of, e.g., EPDM rubber (ethylene propylene diene monomer rubber).

However, when a rubber hose is used as the hose 60 which couples the motor pump 52 and the respective nozzles 54, 56 in the headlamp cleaner, a pressure loss is high and the number of components is large. More specifically, in order to clean the headlamp by ejecting the cleaning fluid, the cleaning fluid needs to be pressurized by the motor pump 52, and thus pressurized cleaning fluid needs to be supplied to the nozzles 54, 56. However, a pressure generated by a pressure-transfer of the cleaning fluid acts on the hose 60, whereby the rubber 60 expands in its radial direction and the pressure loss becomes high as a sectional area of the fluid path increases. In addition, because the tank 50 is generally not arranged at a center but on a right side or a left side of the vehicle, the fluid path connecting the motor pump 52 and the nozzle 54 for cleaning a right headlamp and the fluid path connecting the motor pump 52 and the nozzle 56 for cleaning a left headlamp are different in length Therefore, a portion of the hose 60 forming the longer fluid path has a higher pressure loss than a portion of the hose 60 forming the shorter fluid path. Thus, the pressure loss becomes unbalanced between the respective portions of the hose 60.

Meanwhile, the fluid path 58 of the headlamp cleaner is arranged by utilizing a space between a body structure of the vehicle and accessories thereof. Therefore, the fluid path 58 needs to be bent in order to avoid interference with vehicle components.

The bent portion may be formed (1) by arranging an L-shaped plastic joint 62, or (2) by bending the rubber hose 60 by molding. However, in the case of (1), since the joint 62 and the hoses 60 are separate components, they need to be fixed by providing a clip 64 at a connecting portion therebetween. Therefore, the number of sections of the rubber hose 60, joints 62 and clips 64 increases in accordance with the number of the bent portions. Accordingly, the number of the components and the weight of the fluid path 58 increase.

Further, the corner 62a formed inside in the L-shape joint 62 hinders a flow of the cleaning fluid (see FIG. 8).

In the case of (2), depending on a molding condition of the rubber hose 60, there may be a case where a required space is large or the rubber hose 60 cannot be formed.

### SUMMARY OF INVENTION

It is an object of the present invention to provide a headlamp cleaner in which a weight and the number of components are reduced, and a pressure loss in a fluid path is lowered.

According to an aspect of the invention, a headlamp cleaner includes a tank in which a cleaning fluid is stored, a motor pump which pumps the cleaning fluid stored inside the tank, a fluid path through which the cleaning fluid pumped by the motor pump is pressure-transferred, and a nozzle from which the cleaning fluid pressure-transferred through the fluid path is ejected toward a headlamp. The fluid path mainly includes a hose made of a rigid material such as plastic.

### BRIEF DESCRIPTION OF THE DRAWINGS

FIG. 1 is a view showing an entire arrangement of a headlamp cleaner according to an exemplary embodiment of the invention;

FIG. 2 is an enlarged plan view showing a part of a fluid path connecting a nozzle and a motor pump;

FIG. 3 is an enlarged sectional view showing a relationship between a T-shaped joint and hoses;

FIG. 4 is an enlarged plan view showing a part of a fluid path according to another exemplary embodiment of the

FIG. 5A is an enlarged sectional view of a bent portion of a hose;

FIG. 5B is a sectional view taken along line B-B in FIG. 5A;

FIG. 5C is another sectional view taken along line C-C in FIG. 5A;

FIG. 5D is another sectional view taken along line D-D in FIG. 5A;

FIG. 6 is an enlarged sectional view of a part of a fluid path;

FIG. 7 is a view showing an entire arrangement a headlamp cleaner according to a related art; and

FIG. 8 is an enlarged plan view of a part of a fluid path according to the related art.

### DESCRIPTION OF EXEMPLARY EMBODIMENTS

Hereinafter, exemplary embodiments of the invention will be explained with reference to the drawings. The following exemplary embodiments do not limit the scope of the invention.

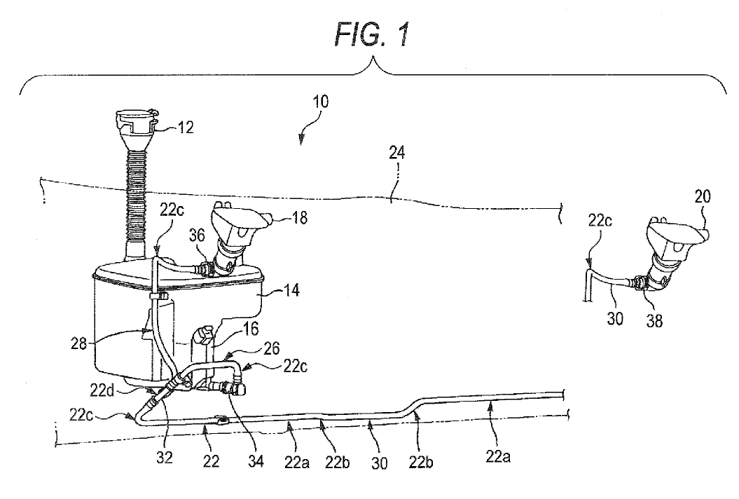

As shown in FIG. 1, a headlamp cleaner 10 includes a tank 14 in which a cleaning fluid injected from an injecting opening 12 is stored, a motor pump 16 which pumps the cleaning fluid inside the tank 14, a plurality of nozzles 18, 20 which ejects the cleaning fluid pressure-transferred from the motor pump 16 toward respective headlamps (not shown) arranged on right and left sides of a vehicle, and a fluid path 22 which couples the motor pump 16 and the respective nozzles 18, 20. The headlamp cleaner 10 is arranged on a rear side of a vehicle bumper 24.

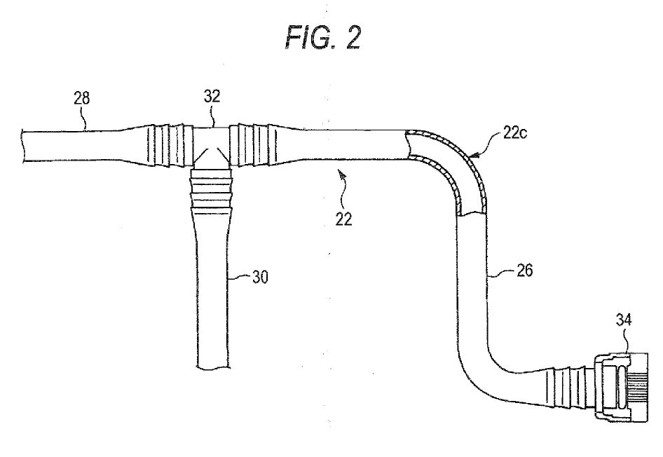

The fluid path 22 mainly includes plastic hoses 26, 28, 30. The fluid path 22 also includes a T-shaped joint 32 which may be made of polyacetal, and connectors 34, 36, 38. Each of the plastic hoses 26, 28, 30 includes at least one of a linear portion 22a, a curved portion 22b and a bent portion 22c of the fluid path 22. The T-shaped joint 32 is arranged only at a branched portion 22d of the fluid path 22. Namely, the linear portion 22a, the curved portion 22b and the bent portion 22c, which constitutes a main part of the fluid path 22, is formed by the plastic hoses 26, 28, 30, whereby a gentle curving angle can be created at the bent portion 22c of the fluid path 22 (see FIG. 2).

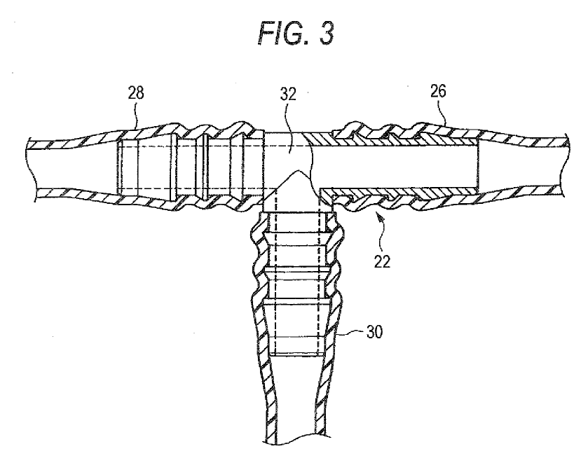

One end of the plastic hose 26 is coupled to the connector 34 by press-fitting whereas the other end thereof is coupled to the T-shaped joint 32 by press-fitting. One end of the plastic hose 28 is coupled to the connector 36 by press-fitting whereas the other end thereof is coupled to the T-shaped joint 32 by press-fitting. One end of the plastic hose 30 is coupled to the connector 38 by press-fitting whereas the other end thereof is coupled to the T-shaped joint 32 by press-fitting (see FIG. 3).

The plastic hoses 26, 28, 30 are made of plastic, e.g., thermoplastic resin such as nylon which is high in chemical resistance. Other possible materials for the hoses 26, 28, 30 may be polypropylene, polycarbonate, polyacetal, or ABS resin. According to the exemplary embodiment, the plastic hoses 26, 28, 30 are made of PA12 (polyamide 12).

According to such a configuration, when the motor pump 16 is driven, the cleaning fluid inside the tank 14 is pumped by the motor pump 16. The cleaning fluid thus pumped is pressure-transferred to the respective nozzles 18, 20 via the fluid path 22. Accordingly, the surface of the headlamp is cleaned by the cleaning fluid ejected from the respective nozzles 18, 20. Thus, even when functionality (e.g., a light distribution) of the headlamp is lowered due to adhesion of dirt, the functionality of the headlamp can be restored by cleaning the headlamp by means of the headlamp cleaner 10, thereby ensuring a visibility.

When the cleaning fluid is pressure-transferred to the respective nozzles 18, 20 from the motor pump 16, the pressure due to the pressure-transfer of the cleaning fluid acts onto the fluid path 22. However, since the fluid path 22 is mainly formed of the plastic hoses 26, 28r 30 which do not expand in their radial directions, the sectional area of the flow path is prevented from being increased. Thus, the pressure loss in the fluid path 22 can be reduced. In addition, the pressure loss is balanced between the plastic hoses 26, 28 serving as the fluid path connecting the nozzle 18 for cleaning the right headlamp and motor pump 16 and the plastic hoses 26, 30 serving as the fluid path connecting the nozzle 20 for cleaning the left headlamp and motor pump 16, although the respective fluid paths are different in length. Moreover, since the pressure loss in the fluid path 22 can be reduced, the pumping pressure of the motor pump 16 can be lowered while ejecting the cleaning fluid from the nozzles 18, 20 with same the pressure. Thus, downsizing of the motor pump 16 becomes possible.

Because the bent portion 22c of the fluid path 22 is also formed by the plastic hoses 26, 28, 30, the fluid path 22 can be assembled by coupling the plastic hose 26 to the plastic hose 28 via the T-shaped joint 32, coupling the plastic hose 26 to the plastic hose 30 via the T-shaped joint 32, and press-fitting the connectors 34, 36, 38 to the respective ends of the plastic hoses 26, 28, 30, without using an L-shape joint or a clip. Thus, the number of components can be reduced as compared with a headlamp cleaner in which the fluid path other than a bent portion and a branched portion is formed of the rubber hose and in which a joint is provided at the branched portion and the bent portion.

According to the above-described exemplary embodiment, since the fluid path 22 connecting the motor pump 16 and the respective nozzles 18, 20 is mainly formed of the plastic hoses 26, 28, 30 including the bent portion 22c, the number of components can be reduced, and the weight of the fluid path can be reduced. In addition, the pressure loss in the fluid path 22 can be reduced.

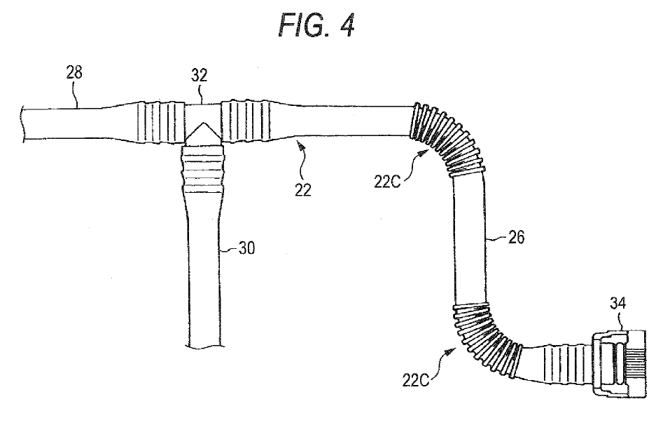

Next, referring to FIG. 4, an explanation will be given to another exemplary embodiment of the invention. In this exemplary embodiment, the plastic hoses 26, 28, 30 forming the fluid path 22 are partially corrugated, and the remaining configuration is the same as the previous exemplary embodiment.

Specifically, a part of the plastic hoses 26, 28, 30, e.g., a portion corresponding to the bent portion 22c of the plastic hoses 26, 28, 30 is corrugated.

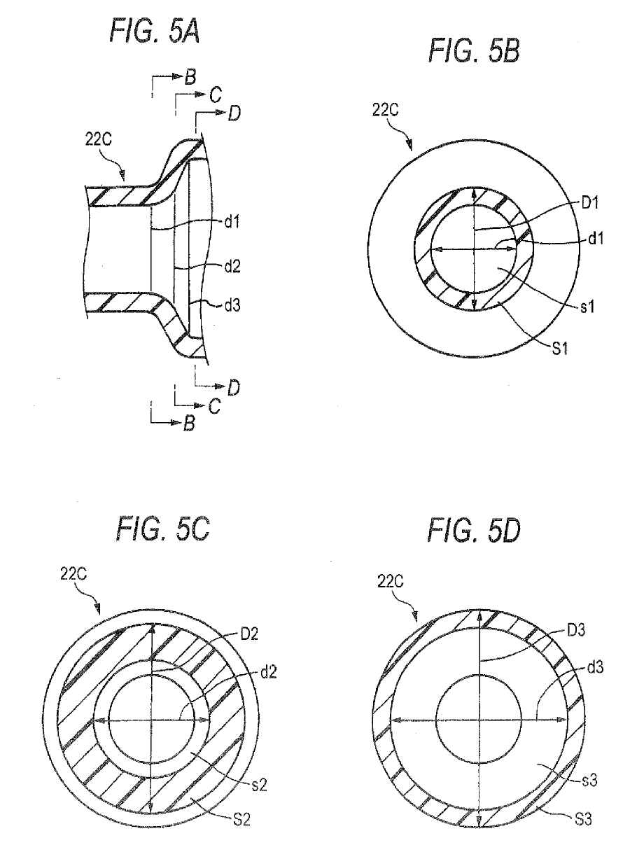

FIG. 5A is an enlarged sectional view of the bent portion 22c having a minimum internal diameter d1, a maximum internal diameter d3, and an intermediate internal diameter d2. As shown in FIGS. 5B to 5D, there is a relationship s1<s2<s3 where s1 is an internal sectional area (a flow-path sectional area) at a section having the minimum internal diameter d1, s3 is an internal sectional area (the flow-path sectional area) at a section having the maximum internal diameter d3, and s2 is an internal sectional area (the flow-path sectional area) at a section having the intermediate internal diameter d2. Namely, the bent portion 22c is corrugated such that the internal sectional area (the flow-path sectional area) s1, s2, s3 of the fluid path 22 in its radial direction gradually changes along the longitudinal direction of the fluid path 22.

In the plastic hoses 26, 28, 30, the pressure loss is reduced when pressure-transferring the cleaning fluid, as compared with a rubber hose. However, since elasticity of the plastic hoses 26, 28, 30 is inferior, it is difficult to bend them appropriately at the time of piping if the entire body thereof remains cylindrical. For this reason, the portion corresponding to the bent portion 22c of the plastic hoses 26, 28, 30 is corrugated such that a flow volume of the cleaning fluid per unit sectional area gradually changes, thereby providing flexibility in the corrugated portion. Consequently, when arranging the plastic hoses 26, 28, 30 to a vehicle body on an inner side of a bumper, a portion corresponding to the bent portion 22c can be freely bent so that the plastic hoses 26, 28, 30 can be piped without securing the bent portion 22c with a joint or a clip.

Since a component such as a joint or a clip is not required when arranging the plastic hoses 26, 28, 30, a cost for the components can reduced and the weight of the fluid path 22 can be reduced. In addition, since the plastic hose can be freely bent, a margin length in assembling can be assured so that operability can be improved.

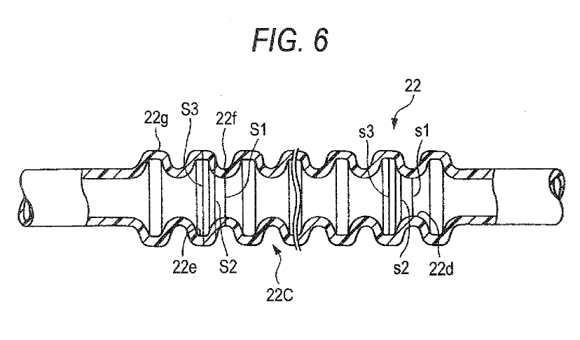

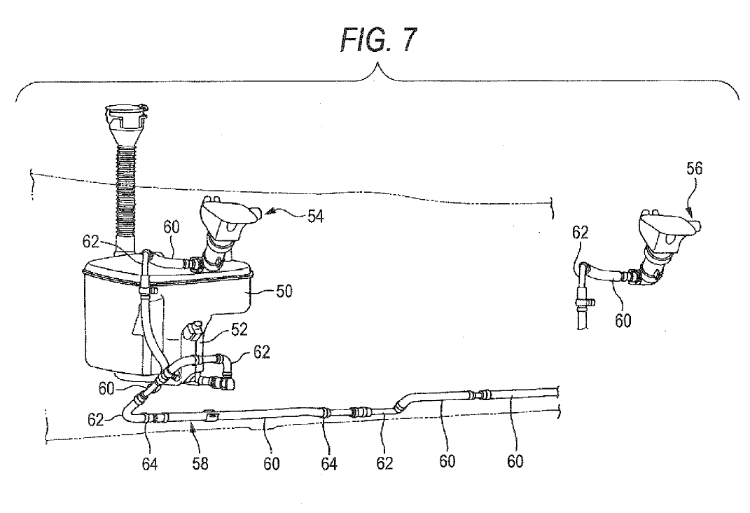

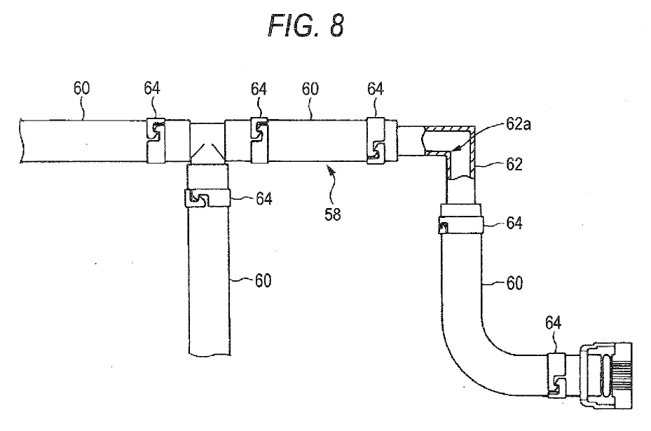

As shown in FIG. 6, the portion corresponding to the bent portion 22c of the plastic hoses 26, 28, 30 is corrugated such that an internal convex portion 22d, an internal concave portion 22e, an external concave portion 22f and an external flat portion 22g are respectively formed at regular intervals.

In FIGS. 5B to 5D, as described previously, d1 is the minimum internal diameter, d3 is the maximum internal diameter d3, and d2 is the intermediate internal diameter d2 of the bent portion 22c, and the relationship between the internal sectional area (a flow-path sectional area) s1 at the section having the minimum internal diameter d1, the internal sectional area (the flow-path sectional area) s3 at the section having the maximum internal diameter d3, and the internal sectional area (the flow-path sectional area) s2 at the section having the intermediate internal diameter d2 is s1<s2<s3. Further, D1 is a minimum external diameter, D3 is a maximum external diameter, and D2 is an intermediate diameter of the bent portion 22c. As shown in FIGS. 5B to 5D, there is a relationship S1<S2<S3 where S1 is an external sectional area at a section having the minimum external diameter D1, S3 is the external sectional area at a section having the maximum internal diameter D3, and S2 is the external sectional area at a section having the intermediate internal diameter D2.

Specifically, the internal convex portion 22d includes, at a middle portion thereof, a region where the internal sectional area (the flow-path sectional area) of the fluid path 22 in the radial direction becomes the minimum value s1. The internal convex portion 22d is formed so as to protrude inwardly inside the fluid path 22 such that a section along a longitudinal direction of the fluid path 22 becomes a continuously curved section. The internal concave portion 22e includes, at a middle portion thereof, a region where the internal sectional area (the flow-path sectional area) of the fluid path 2 in the radial direction becomes the maximum value s3. The internal concave portion 22e is formed so as to be dented outwardly inside the fluid path 22 such that a section along a longitudinal direction of the fluid path 22 becomes a continuously curved section.

The external concave portion 22f includes, at a middle portion thereof, a region where the external sectional area of the fluid path 22 in the radial direction becomes the minimum value S1. The external concave portion 22f is formed so as to be dented inwardly on an outer peripheral side of the fluid path 22 such that a section along a longitudinal direction of the fluid path 22 becomes a continuously curved section. The external flat portion 22g is formed such that the outer diameter of the fluid path 22 is constant and such that a section along a longitudinal direction of the fluid path 22 becomes a flat section.

According to the above configuration, when piping the plastic hoses 26, 28, 30, the fluid path 22 can be formed only by coupling the plastic hose 26 and plastic hose 28 via the T-shaped joint 32, coupling the plastic hose 26 and plastic hose 30 via the T-shaped joint 32, and press-fitting the connectors 34, 36, 38 to the respective ends of the plastic hoses 26, 28, 30. Thus, an L-shape joint or a clip is not required. Further, since the portion corresponding to the bent portion 22c is corrugated, this portion can be easily bent and also maintained in its bent state without being secured by means of an L-shape joint or a clip. Thus, as compared with the configuration in which the fluid path other than a bent portion or a branched portion is formed of a rubber hose and in which a joint is provided at the branched portion or the bent portion, the number of components can be reduced, and the assembling property can be enhanced. Meanwhile, the bent portion 22c may be secured by an auxiliary clip, thereby securing the bent portion 22c more firmly.

According to an exemplary embodiment, since the fluid path 22 is mainly formed of the plastic hoses 26, 28, 30 including the bent portions 22c, the number of components can be reduced, and the weight of the fluid path as well as a cost can be reduced. In addition, the pressure loss within the fluid path can be reduced.

Further, since the portion corresponding to the bent portion 22c of the plastic hoses 26, 28, 30 is corrugated, the portion corresponding to the bent portion 22c can be bent arbitrarily when piping the plastic hoses 26, 28, 30, without securing the bent portion 22c by a joint or a clip. Therefore the assembling property is enhanced and cost is reduced.

Further, since the internal convex portion 22d having a curved section along the longitudinal direction of the fluid path 22 is formed on the corrugated portion (the bent portion 22c), the cleaning fluid inside the fluid path flows more smoothly than in a case where a corner is formed on an inner side of the fluid path 22 by corrugating. In addition, the internal concave portion 22e and external concave portion 2f, both having a curved section along the longitudinal direction of the fluid path 22, are formed on the corrugated portion (the bent portion 22c). Therefore, even when a force due to a bending processing acts on the corrugated portion (the bent portion 22c), the force is not concentrated unlike a case where a corner is formed on an inner side or an outer side of the fluid path 22, thereby preventing the corrugated portion (the bent portion 22c) from being broken.

When corrugating the fluid path 22, the portion other than the bent portion 22c, e.g., the linear portion 22a or a curved portion 22b may also be corrugated.

When partially corrugating the fluid path 22, a heat treatment step for keeping the corrugated portion bent at a predetermined angle may be added to a plastic molding step of the plastic hoses 26, 28, 30, whereby the plastic hoses 26, 28, 30 can be used with the corrugated portion being previously bent at a predetermined angle, e.g., at a bending angle corresponding to the bent portion 22c.

While description has been made in connection with exemplary embodiments of the present invention, it will be obvious to those skilled in the art that various changes and modification may be made therein without departing from the present invention. It is aimed, therefore, to cover in the appended claims all such changes and modifications falling within the true spirit and scope of the present invention.

What is claimed is:

1. A headlamp cleaner comprising:
a tank in which a cleaning fluid is stored;
a motor pump which pumps the cleaning fluid stored inside the tank;
a fluid path through which the cleaning fluid pumped by the motor pump is pressure-transferred; and
a nozzle from which the cleaning fluid pressure-transferred through the fluid path is ejected toward a headlamp,
wherein the fluid path comprises a hose made of plastic.

2. The headlamp cleaner according to claim 1, wherein at least a part of the hose is corrugated such that an internal sectional area of the fluid path in a radial direction thereof gradually changes along a longitudinal direction of the fluid path.

3. The headlamp according to claim 2, wherein the corrugated part of the hose comprises an internal convex portion including, at a middle portion thereof, a region where the internal sectional area of the fluid path in the radial direction becomes a minimum, and wherein a section of the internal convex portion along the longitudinal direction of the fluid path is curved.

4. The headlamp according to claim 2, wherein the corrugated part of the hose comprises:
an internal concave portion including, at a middle portion thereof, a region where the internal sectional area of the fluid path in the radial direction becomes a maximum; and
an external concave portion including, at a middle portion thereof, a region where an external sectional area of the fluid path in the radial direction becomes a minimum,
wherein sections of both the internal concave portion and the external concave portion along the longitudinal direction of the fluid path are curved.

5. The headlamp according to claim 3, wherein the corrugated part of the hose further comprises:
an internal concave portion including, at a middle portion thereof, a region where the internal sectional area of the fluid path in the radial direction becomes a maximum; and
an external concave portion including, at a middle portion thereof, a region where an external sectional area of the fluid path in the radial direction becomes a minimum,
wherein sections of both the internal concave portion and the external concave portion along the longitudinal direction of the fluid path are curved.

6. The headlamp cleaner according to claim 1, further comprising another nozzle from which the cleaning fluid pressure-transferred through the fluid path is ejected toward another headlamp,
wherein the fluid path further includes a branched portion, and
the hose includes a first hose portion connecting the motor pump and the branched portion, a second hose portion connecting the nozzle and the branched portion, and a third hose portion connecting the another nozzle and the branched portion.
